(19) United States
(12) Patent Application Publication
(10) Pub. No.: US 2023/0086981 A1
(43) Pub. Date: Mar. 23, 2023

(54) PERSON SEARCH SYSTEM, PERSON SEARCH METHOD AND STORAGE MEDIUM

(71) Applicant: NEC Corporation, Minato-ku, Tokyo (JP)

(72) Inventor: Taketo KOCHI, Tokyo (JP)

(73) Assignee: NEC Corporation, Minato-ku, Tokyo (JP)

(21) Appl. No.: 17/801,871

(22) PCT Filed: Mar. 23, 2020
(86) PCT No.: PCT/JP2020/012715

§ 371 Date: Aug. 24, 2022

(51) Int. Cl. G06F 16/2457

(52) U.S. Cl. CPC G06F 16/24578

(57) ABSTRACT

This person search system is provided with: a receiving means which receives the input of search keywords for searching for a person in an organization; a search means which searches for persons associated with the search keywords received by the receiving means; an acquisition means which acquires file information that contains at least a file name associated with persons found by the search means; and a display control means which displays on a display device the file information acquired by the acquisition unit.

### TECHNICAL FIELD

The present invention relates to a person search system, a person search method, and a storage medium.

### BACKGROUND ART

In order to efficiently search for a person related to a specific technology, field, product, project, or the like in an organization or group such as a company, the relevance between the person and the word may be calculated and evaluated.

An example of a technique used for calculating such relevance is disclosed in PTL 1. According to PTL 1, an output unit 8 arranges and outputs a plurality of person names obtained as a search result in descending order of related scores.

### CITATION LIST

### Patent Literature

[PTL 1] JP 2019-86940 A

### SUMMARY OF INVENTION

### Technical Problem

As disclosed in PTL 1, even if a plurality of person names are output in a descending order of related scores, there is a case where a person that the searcher desires to contact does not necessarily match a person with a high related score. Therefore, there is a case where it is difficult for the searcher to determine whether the person is a person he/she wants to contact.

In view of the above-described problems, an object of the present invention is to provide a person search system, a person search method, and a storage medium that make it easy for the searcher to determine whether he/she wants to contact a person.

### Solution to Problem

A person search system according to the present invention includes receiving means configured to receive an input of search keywords for searching for a person in an organization, search means configured to search for persons associated with the search keywords received by the receiving means, acquisition means configured to acquire file information that includes at least a file name associated with persons searched for by the search means, and display control means configured to display on a display device the file information acquired by the acquisition means.

A person search method according to the present invention includes receiving an input of a search keyword for searching for a person in an organization, searching for persons associated with the received search keyword, acquiring file information including at least a file name associated with the searched person, and causing a display device to display the acquired file information.

A storage medium according to the present invention stores a program for causing a computer to function as receiving means configured to receive an input of search keywords for searching for a person in an organization, search means configured to search for persons associated with the search keywords received by the receiving means, acquisition means configured to acquire file information that includes at least a file name associated with persons searched for by the search means, and display control means configured to display on a display device the file information acquired by the acquisition means.

### Advantageous Effects of Invention

According to the present invention, a searcher can easily determine whether a searched person is a person he/she wants to contact.

### BRIEF DESCRIPTION OF DRAWINGS

FIG. 1 is an example of functional blocks of a person search system according to a first example embodiment.

FIG. 2 is an example of a search keyword reception screen displayed on a display unit.

FIG. 3 is an example of a degree of relevance between a person and a word stored in a relevance degree information storage unit.

FIG. 4 is an example of a search result screen displayed by the display unit.

FIG. 5 is an example of file information stored in a file information storage unit.

FIG. 6 is an example of file information displayed by the display unit.

FIG. 7 is an example of a flowchart according to the first example embodiment.

FIG. 8 is an example of file information displayed by the display unit.

FIG. 9 is an example of functional blocks of the person search system according to a modification example of the first example embodiment.

FIG. 10 is an example of the search result screen and the file information displayed on the display unit.

FIG. 11 is an example of a flowchart according to a modification example of the first example embodiment.

FIG. 12 is an example of functional blocks of a person search system according to a second example embodiment.

FIG. 13 is an example of file information stored in a file information storage unit.

FIG. 14 is an example of a detailed information screen displayed by the display unit.

FIG. 15 is an example of a flowchart according to the second example embodiment.

FIG. 16 is an example of functional blocks of the person search system according to a modification example of the second example embodiment.

FIG. 17 is an example of the search result screen displayed by the display unit.

FIG. 18 is an example of a flowchart according to a modification example of the second example embodiment.

FIG. 19 is an example of functional blocks of a person search system according to a third example embodiment.

FIG. 20 is an example of a top screen after login displayed on the display unit.

FIG. 21 is an example of a flowchart according to the third example embodiment.

FIG. 22 is an example of functional blocks of a person search system according to a fourth example embodiment.

FIG. 23 is a block diagram illustrating an example of hardware constituting each unit of each example embodiment of the present invention.

### EXAMPLE EMBODIMENT

Hereinafter, a person search system, a person search method, and a storage medium will be described with reference to the drawings.

### First Example Embodiment

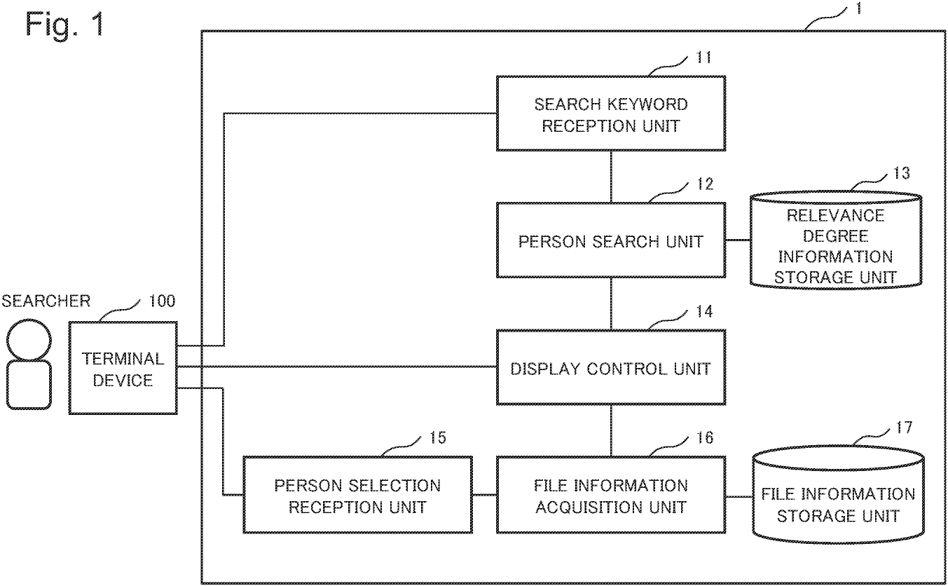

FIG. 1 is an example of functional blocks of a person search system according to a first example embodiment. As illustrated in FIG. 1, a person search system 1 includes a search keyword reception unit 11, a person search unit 12, a relevance degree information storage unit 13, a display control unit 14, a person selection reception unit 15, a file information acquisition unit 16, and a file information storage unit 17. A terminal device 100 includes a display device such as a display.

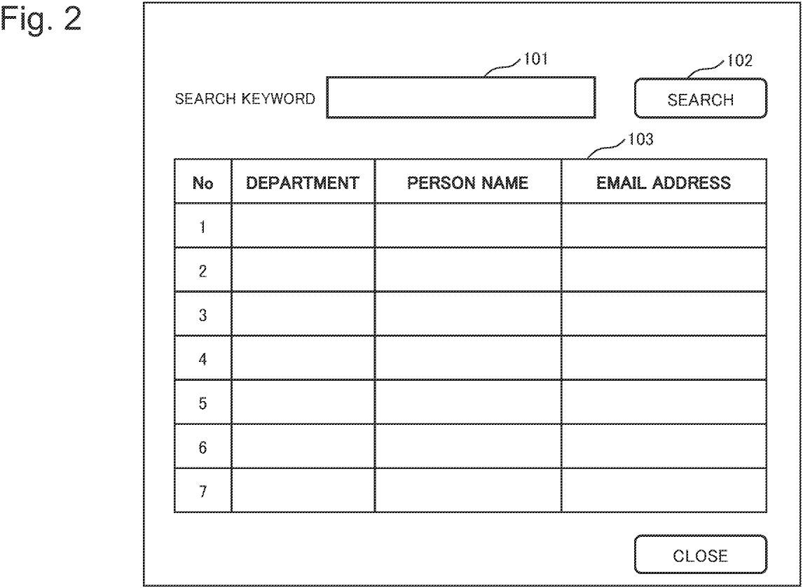

Hereinafter, each functional block constituting the person search system 1 will be described in detail with reference to FIG. 2 and subsequent drawings in addition to FIG. 1.

The display control unit 14 controls the terminal device 100 to display various display screens. A specific display screen will be described later.

The search keyword reception unit 11 receives a search keyword for searching for a person in the organization from the terminal device 100. The search keyword is input from the terminal device 100 by a searcher. The search keyword reception unit 11 outputs the received search keyword to the person search unit 12.

FIG. 2 is a diagram illustrating a search screen displayed on the terminal device 100 by the display control unit 14. The search screen illustrated in FIG. 2 includes, for example, an input box 101 for inputting a search keyword, a search button 102, and a search result display area 103 for displaying a search result.

When the searcher inputs a search keyword (for example, “Work style reform”) into the input box 101 and presses the search button 102, the search keyword reception unit 11 receives the keyword input into the input box 101.

The person search unit 12 searches for a person name having a high degree of relevance with the input search keyword based on the search keyword input from the search keyword reception unit 11 and the relevance degree information stored in the relevance degree information storage unit 13. The person search unit 12 outputs the searched person name to the display control unit 14.

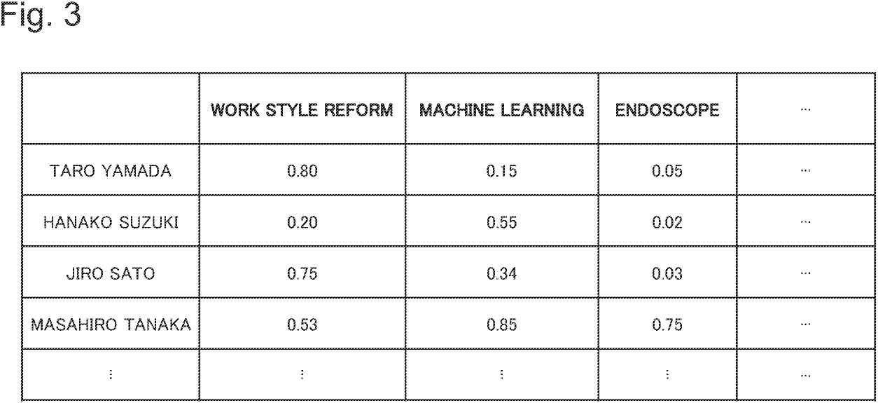

FIG. 3 is a diagram illustrating relevance information stored in the relevance degree information storage unit 13. As illustrated in FIG. 3, the relevance degree information is information in which a degree of relevance to each search keyword is assigned to each person. The degree of relevance is a value indicating the strength of the relevance between the person and the search keyword. The degree of relevance may be ranked by dividing a value indicating strength of relevance into several values. The strength of the relevance indicates, for example, the details of the person regarding the content indicated by the search keyword and the frequency with which the person comes in contact therewith in business regarding the content indicated by the search keyword. The degree of relevance may be calculated by, for example, the time during which the person activates the file including the search keyword and the number of times the person touches the file including the search keyword. In addition, the degree of relevance may be a value reflecting information manually set when the person and the search keyword are associated. Furthermore, the degree of relevance may be set based on not only the relationship between the person and the search keyword but also the strength of the relevance between the search keyword and the search keyword. In addition, the search keywords included in the relevance degree information storage unit 13 may be excluded in advance from keywords that can be assumed to be unlikely to be different for each of persons and are not useful in person search, such as “reception tray”.

The person search unit 12 searches for a person having a high degree of relevance with respect to the input search keyword with reference to, for example, the relevance degree information illustrated in FIG. 3. Specifically, the person search unit 12 acquires the person names of the predetermined number of people in descending order of the degree of relevance with respect to the search keyword matching the input search keyword among the search keywords of the relevance degree information.

For example, in a case where the input search keyword is “Work style reform”, the person search unit 12 acquires the person names “Taro YAMADA”, “Jiro SATO”, and “Masahiro TANAKA” of a predetermined number of people (for example, 3 people) in descending order of relevance to the “Work style reform”, as illustrated in FIG. 3.

The display control unit 14 controls the terminal device 100 to display the person name searched by the person search unit 12.

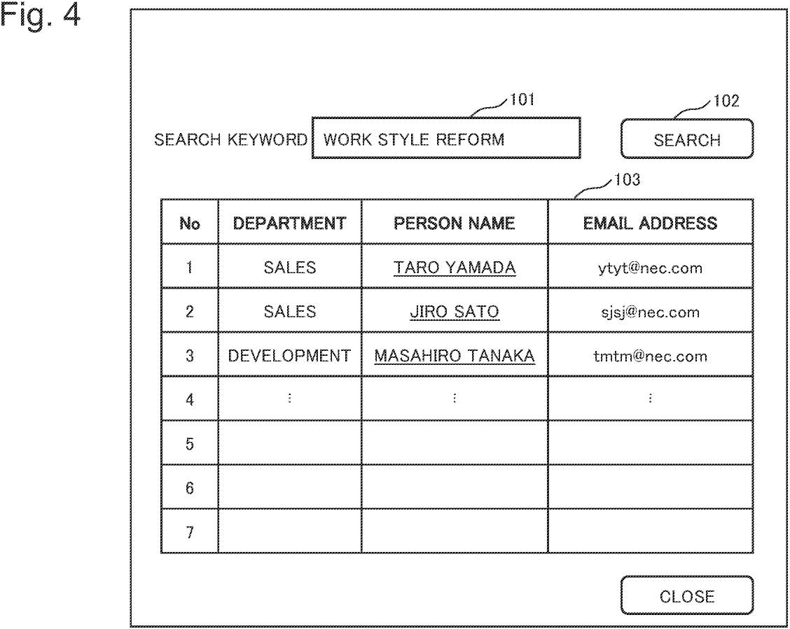

FIG. 4 illustrates an example in which the person search result is displayed in the search result display area 103 of the search result screen illustrated in FIG. 2. As illustrated in FIG. 4, the person names searched by the person search unit 12 and departments and email addresses of the people are displayed in the search result display area 103. For example, the person search unit 12 acquires the department and the email address of the person from person attribute information stored in a person attribute information storage unit (not illustrated).

The person selection reception unit 15 receives selection of a person name to be an acquisition target of file information (described later) from among the person names searched by the person search unit 12 and displayed on the terminal device 100 by the display control unit 14. The person selection reception unit 15 outputs the received person name to the file information acquisition unit 16.

For example, when the searcher selects the person name displayed in the search result display area 103 illustrated in FIG. 4 with a mouse or the like, the person selection reception unit 15 receives the selected person name. The selection of the person is not limited to the selection of the person name, and may be selection of information that uniquely determines the person, such as the “No.” and the email address illustrated in FIG. 4.

The file information acquisition unit 16 acquires file information associated with the input person name based on the person name input from the person selection reception unit 15 and the file information stored in the file information storage unit 17. The file information acquisition unit 16 outputs the acquired file information to the display control unit 14.

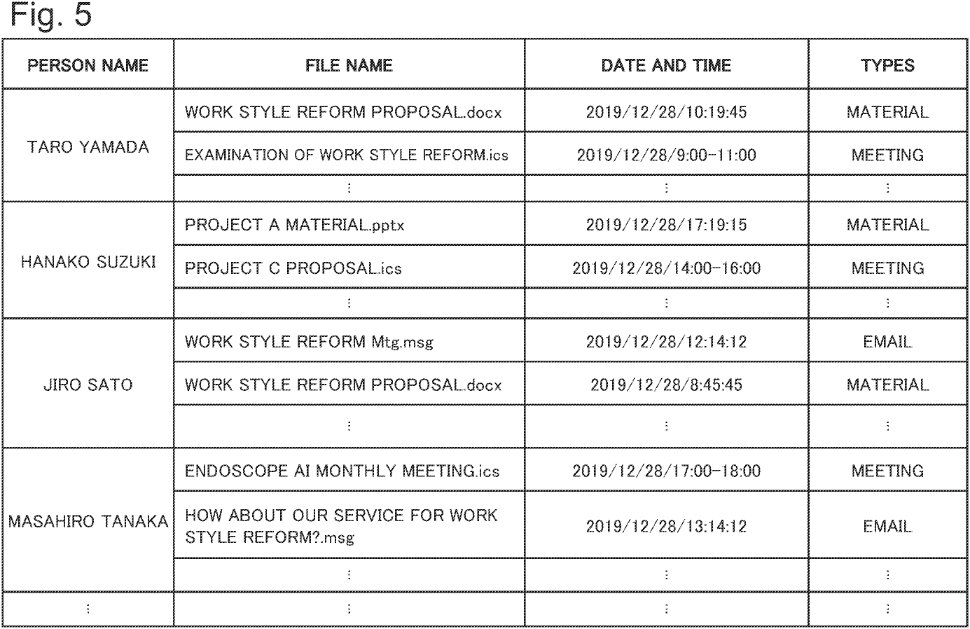

FIG. 5 is a diagram illustrating file information stored in the file information storage unit 17. As illustrated in FIG. 5, in the file information, for example, a person name is associated with a file name, a date and time, and a type of a file used by the person. The file information is collected from, for example, a file that is a target of various operations performed by a person, and is stored in the file information storage unit 17. The various operations are, for example, an operation of opening a file of a person whose file information is to be collected, a keyboard operation on the file, saving of the file, transmission and reception of an email, and update of a schedule. The file information may include a date instead of the date and time.

The file is a collection of data and programs, which is a unit for storing data. For example, the file is a file of Word, Excel (registered trademark), PowerPoint (registered trademark), or the like, and also includes a file of text, schedule, email, or the like. Furthermore, the file may be a collection of data for each predetermined unit of writing such as that of a social networking service (SNS). The predetermined unit is, for example, every date and time when writing has been performed, every person who has performed writing, and every chat room where writing has been performed.

The date and time of the file is not particularly limited as long as it is a date and time related to the file. For example, the date and time of the file is the date and time when the file was last updated, the date and time when the file was created, the date and time when the file was transmitted, or the like.

The type of the file is not particularly limited as long as it indicates the type of the file. For example, the type of the file is “material”, “meeting”, “email”, or the like. The “material” indicates a type of a file used as material. The “meeting” indicates a type of a file related to a schedule such as a meeting notification. The “email” indicates a type of a file of the email. The type of the file may be determined by the extension of the file name.

The file information acquisition unit 16 refers to the file information stored in the file information storage unit 17, and acquires the file information associated with the person name input from the person selection reception unit 15.

For example, in a case where the person selected by the searcher with a mouse or the like in FIG. 4 is “Taro YAMADA”, the file information acquisition unit 16 acquires the file information displayed in the line of “Taro Yamada” illustrated in FIG. 5 and outputs the file information to the display control unit 14.

The display control unit 14 controls the terminal device 100 to display the file information input from the file information acquisition unit 16.

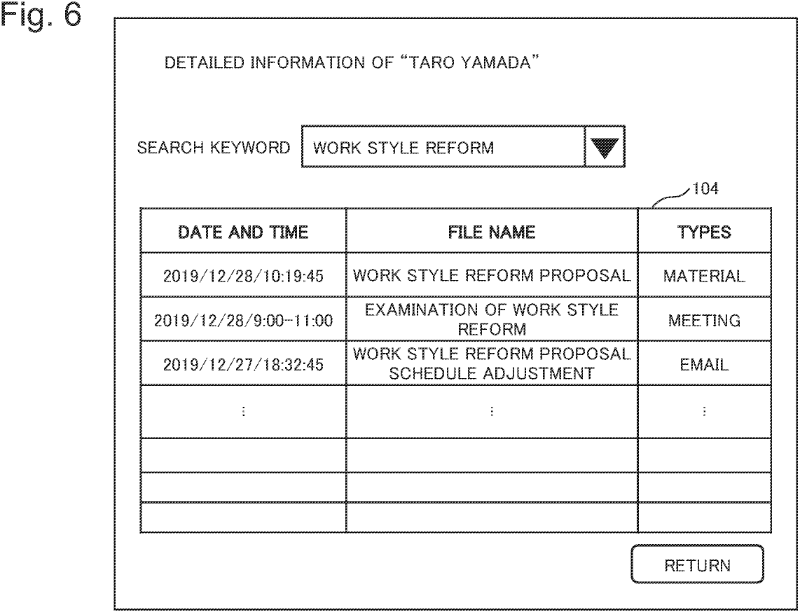

FIG. 6 is a diagram illustrating file information displayed on the terminal device 100 by the display control unit 14. As illustrated in FIG. 6, for example, the date and time, the file name, and the type of the file associated with “Taro YAMADA” received by the person selection reception unit 15 are displayed in a file information display area 104. As illustrated in FIG. 6, for example, the file names are displayed in order of date and time.

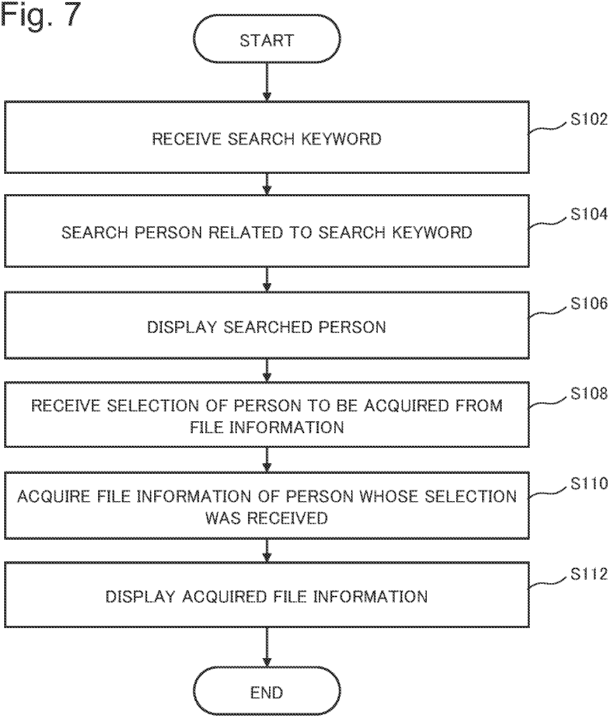

FIG. 7 is an example of a flowchart according to the first example embodiment.

First, the search keyword reception unit 11 receives the search keyword input by the searcher from the terminal device 100 (step S102).

Next, the person search unit 12 searches for the relevance degree information storage unit 13 for a person related to the search keyword received by the search keyword reception unit 11 (step S104).

Next, the display control unit 14 causes the terminal device 100 to display the person searched by the person search unit 12 (step S106).

Next, the person selection reception unit 15 receives selection of an acquisition target person whose file information has been selected by the searcher from the terminal device 100 (step S108).

Next, the file information acquisition unit 16 acquires the file information of the person received by the person selection reception unit 15 from the file information storage unit 17 (step S110).

Then, the display control unit 14 causes the terminal device 100 to display the file information acquired by the file information acquisition unit 16 (step S112).

As described above, according to the first example embodiment, the person search system 1 enables the searcher to ascertain the detailed information on the person output as the search result. By displaying the detailed information, the person search system 1 enables the searcher to easily determine whether the searched person is a person he/she wants to contact.

For example, in the example of FIG. 6, the searcher is searching for a person who is familiar with the work style reform, and is able to know that Taro YAMADA is related to a material of “Work style reform proposal” and is also related to a meeting of “Examination of work style reform”, and thus, it is possible to determine that there is a high possibility that Taro YAMADA is a person whom he wants to contact.

Although the case where the search target and the display target of the file information in the first example embodiment are persons has been described as an example, the search target and the display target of the file information may be a group (department, team, or the like of company) to which a plurality of persons belong.

Furthermore, in the first example embodiment, the case where the person search unit 12 searches for a person based on the degree of relevance with respect to the search keyword matching the input search keyword among the search keywords of the relevance degree information stored in the relevance degree information storage unit 13 has been described as an example. However, in a case where the search keyword matching the input search keyword does not exist in the relevance degree information, the person search unit 12 may search for the person based on the degree of relevance with respect to the search keyword similar to the input search keyword. In this case, for example, the person search unit 12 refers to a similar word storage unit (not illustrated) to acquire a word similar to the input search keyword. The similar word storage unit stores word information in which fluctuations and synonyms of keywords are put together so that synonyms and abbreviations and names distributed in organizations can be treated as the same keyword. The word information stored in the similar word storage unit may be directly registered by the administrator, or may be a result of calculating candidate synonyms based on the vector expression of the word.

Furthermore, in a case where the person search unit 12 has not been able to search for a person, the display control unit 14 may cause the terminal device 100 to display that the person search based on the input search keyword has not been able to be performed. The case where the person search unit 12 cannot search for a person is, for example, a case where a search keyword that matches or is similar to the input search keyword does not exist in the relevance degree information.

Further, in the first example embodiment, the case where the file information acquisition unit 16 acquires all the file information associated with the person name stored in the file information storage unit 17 has been described as an example. Not limited to this, for example, the file information acquisition unit 16 may acquire only file information highly related to the search keyword among the file information associated with the person name. The file information highly related to the search keyword is, for example, file information in which the search keyword is included in the file name. With this processing, the searcher can easily confirm the file information that is particularly highly related to the search keyword, and thus can more efficiently determine the person he/she wants to contact.

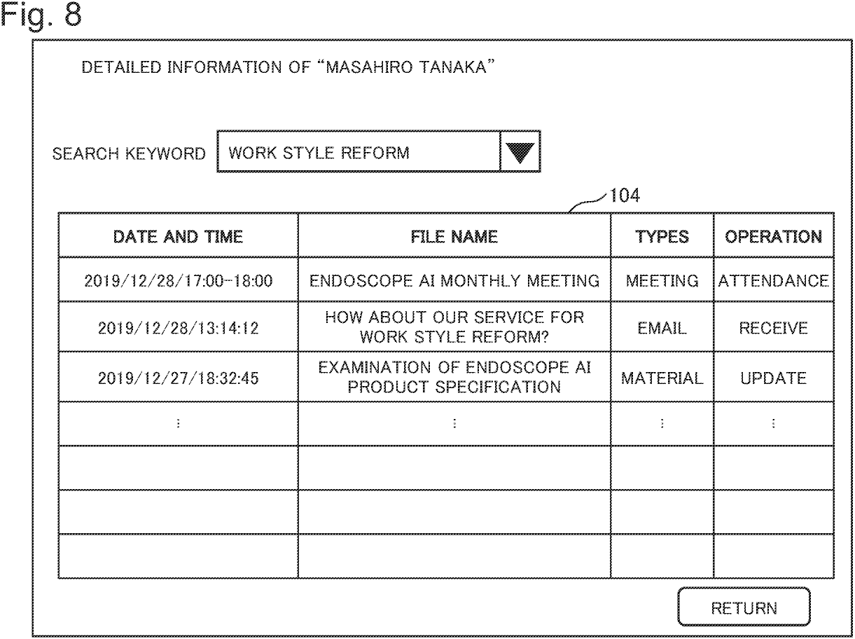

Further, in the first example embodiment, the case where the person name, the file name, the date and time, and the type of the file used by the person are associated with the file information has been described as an example. Not limited to this, for example, the file information may include, for each file associated with each person, various operations performed by the person. The various operations are, for example, creation, browsing, editing, updating, transmission, reception, attendance, and the like. For example, as illustrated in FIG. 8, the operation content is displayed in the file information display area 104 as the file information.

In a case where various operations are included in the file information and the searcher confirms, for example, the display screen illustrated in FIG. 8, it can be seen that Masahiro TANAKA has just received an email of “How about our service for work style reform?”. Therefore, the searcher can determine that the searcher should preferentially contact other people since he/she knows that Masahiro TANAKA just has received sales emails sent to an unspecified number of people.

Furthermore, in the first example embodiment, the case where the display control unit 14 displays the file information in order of date and time has been described as an example. In this case, the searcher can easily confirm the file information recently used by the contact candidate person, and can efficiently determine the person he/she wants to contact. The present invention is not limited thereto, and the display control unit 14 may display the file information in descending order of relevance to the search keyword.

Furthermore, in the first example embodiment, the person search system 1 may include an excluded word storage unit (not illustrated). The excluded word storage unit stores a word that can include information that is not desired to be shown to the user, such as confidential information. The word stored in the excluded word storage unit is arbitrarily changed by the administrator. The file information acquisition unit 16 excludes the file information including the word included in the excluded word storage unit from the acquired file information and outputs the file information to the display control unit 14.

### Modification Example of First Example Embodiment

In the first example embodiment, the case where the searcher selects a person on the person search result screen (FIG. 4) to display detailed information on the selected person (FIG. 6) has been described as an example. As a modification example of the first example embodiment, a configuration in which detailed information of all searched persons is displayed will be described.

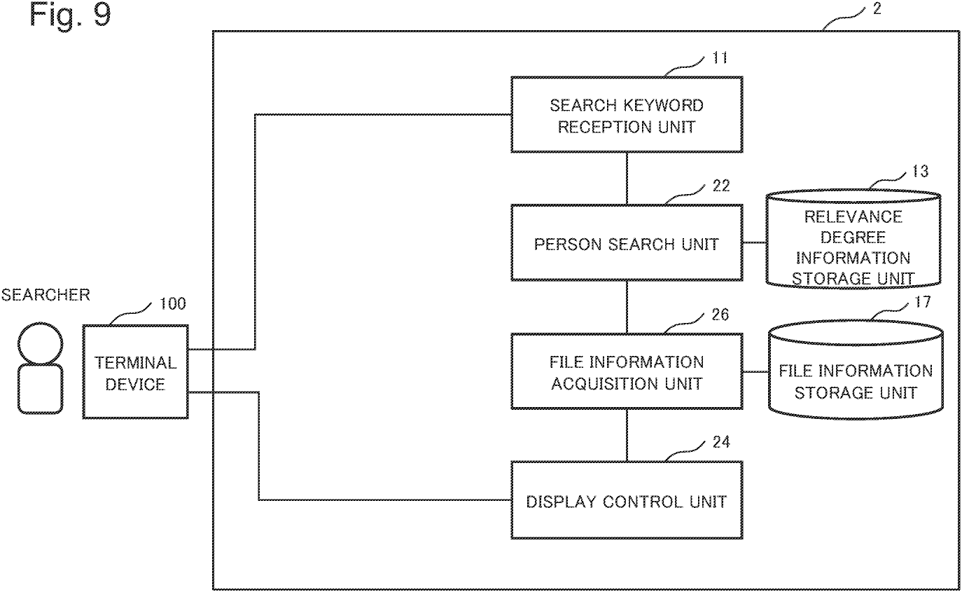

FIG. 9 is a diagram illustrating a configuration of a person search system 2 according to a modification example of the first example embodiment.

Among the components of the person search system 2, components that perform the same processing operations as those of the person search system 1 according to the first example embodiment are denoted by the same reference numerals as those in FIG. 1, and a detailed description thereof will be omitted.

The person search system 2 illustrated in FIG. 9 includes the search keyword reception unit 11, a person search unit 22, a relevance degree information storage unit 13, a file information acquisition unit 26, the file information storage unit 17, and a display control unit 24.

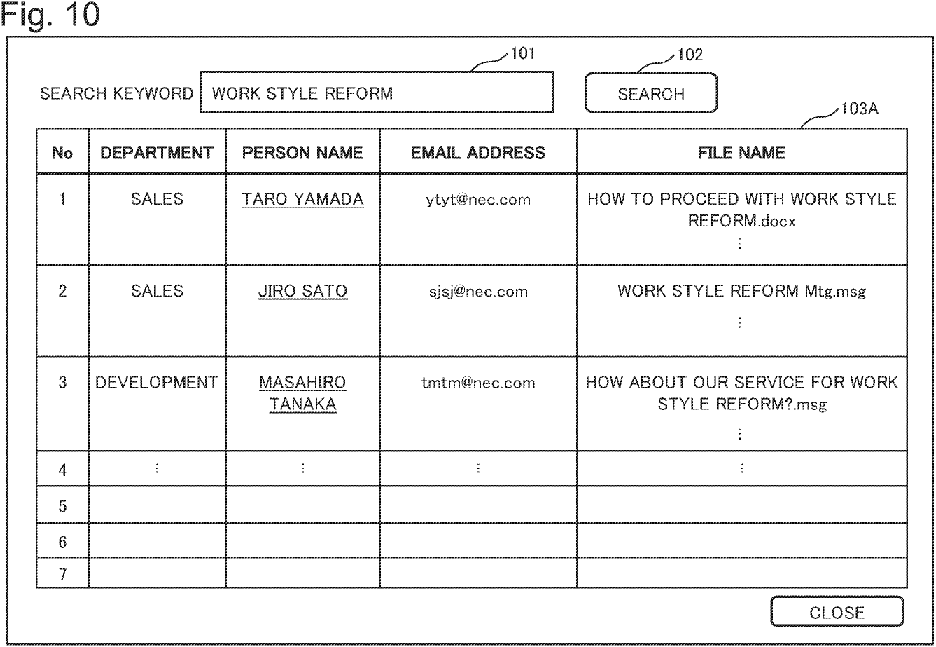

Hereinafter, each functional block constituting the person search system 2 will be described in detail with reference to FIG. 10 and subsequent drawings in addition to FIG. 9.

The person search unit 22 searches for a person with reference to the relevance degree information stored in the relevance degree information storage unit 13. Further, the person search unit 22 acquires person attribute information (affiliation, email address, or the like) of the searched person name from the person attribute information stored in the person attribute information portion not illustrated. The person search unit 22 outputs the person name and the person attribute information of the searched person to the file information acquisition unit 26.

The file information acquisition unit 26 acquires file information associated with the person name of the searched person based on the person name of the person searched by the person search unit 22 and the file information stored in the file information storage unit 17. The file information acquisition unit 26 outputs the acquired file information and the person name and person attribute information acquired from the person search unit 22 to the display control unit 24.

The display control unit 24 controls to display the file information, the person name, and the person attribute information input from the file information acquisition unit 26 on the terminal device 100.

FIG. 10 is an example of the search result screen and the file information displayed on the terminal device 100 by the display control unit 24. A search result display area 103A includes a file name associated with each person in addition to the searched person name and person attribute information. The file information displayed on the screen of FIG. 10 is not limited to the file name, and the date and time, the type, and the like may be displayed.

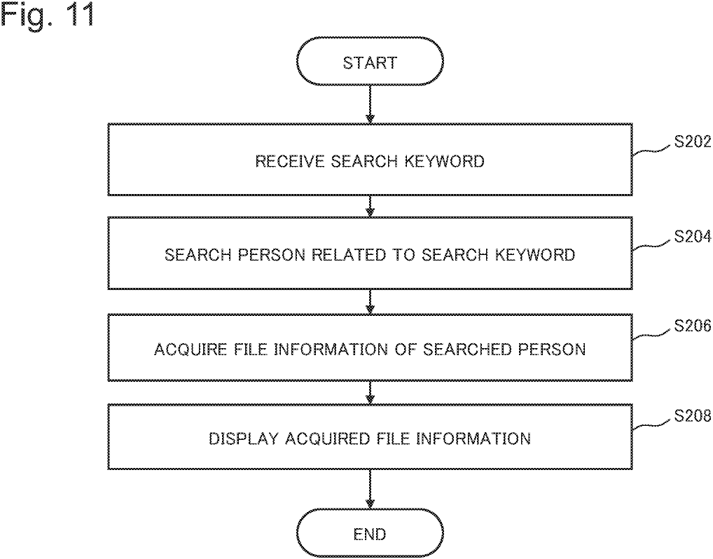

FIG. 11 is an example of a flowchart according to a modification example of the first example embodiment.

First, the search keyword reception unit 11 receives the search keyword input by the searcher from the terminal device 100 (step S202).

Next, the person search unit 22 searches for the relevance degree information storage unit 13 for a person related to the search keyword received by the search keyword reception unit 11 (step S204).

Next, the file information acquisition unit 26 acquires the file information of the person searched by the person search unit 22 from the file information storage unit 17 (step S206).

Then, the display control unit 24 causes the terminal device 100 to display the file information acquired by the file information acquisition unit 26 (step S208).

As described above, according to the modification example of the first example embodiment, the person search system 2 causes the searcher to easily determine a person to be contacted. Since the searcher can know the information of the file related to the person output as the search result, the person to be contacted can be easily selected from the person output as the search result.

In the modification example of the first example embodiment, the case where the person search unit 22 acquires the person name and the person attribute information has been described as an example, but it is not essential to acquire the person attribute information. In a case where the person search unit 22 does not acquire the person attribute information, the display control unit 24 performs control to display the file information and the person name input from the file information acquisition unit 26 on the terminal device 100.

In the modification example of the first example embodiment, the case where the person attribute information acquired by the person search unit 22 is output to the file information acquisition unit 26 has been described as an example, but the person search unit 22 may output the person attribute information to the display control unit 24. In this case, the display control unit 24 controls the terminal device 100 to display the person attribute information input from the person search unit 22, the file information input from the file information acquisition unit 26, and the person name.

### Second Example Embodiment

In the first example embodiment, the case where the searcher selects a person on the person search result screen (FIG. 4) to display detailed information on the selected person (FIG. 6) has been described as an example. As a second example embodiment, a configuration in which detailed information on a related person is displayed by selecting the related person included in the detailed information on the selected person will be described.

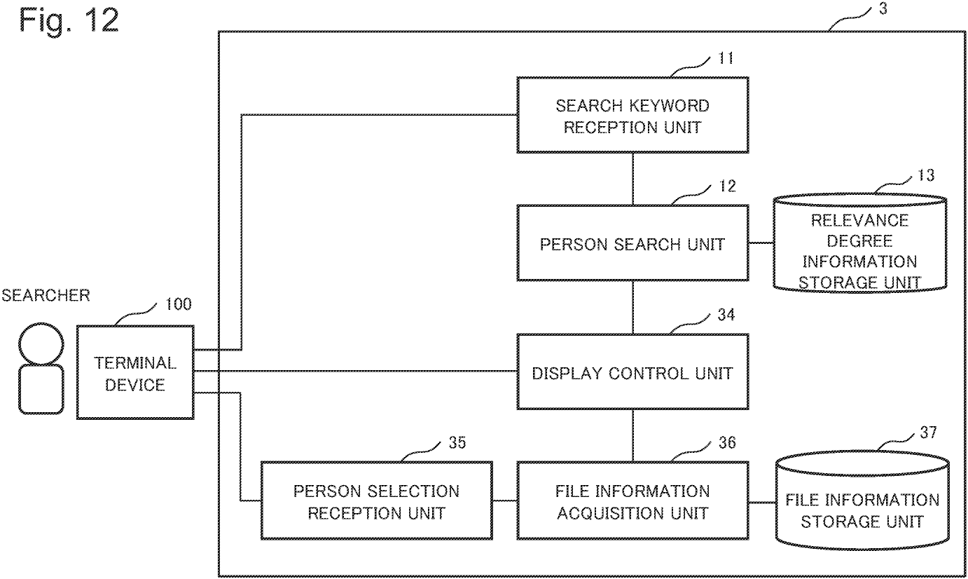

FIG. 12 is a diagram illustrating a configuration of a person search system 3 in the present example embodiment.

Among the components of the person search system 3, components that perform the same processing operations as those of the person search system 1 according to the first example embodiment are denoted by the same reference numerals as those in FIG. 1, and a detailed description thereof will be omitted.

The person search system 3 illustrated in FIG. 12 includes the search keyword reception unit 11, the person search unit 12, the relevance degree information storage unit 13, a display control unit 34, a person selection reception unit 35, a file information acquisition unit 36, and a file information storage unit 37.

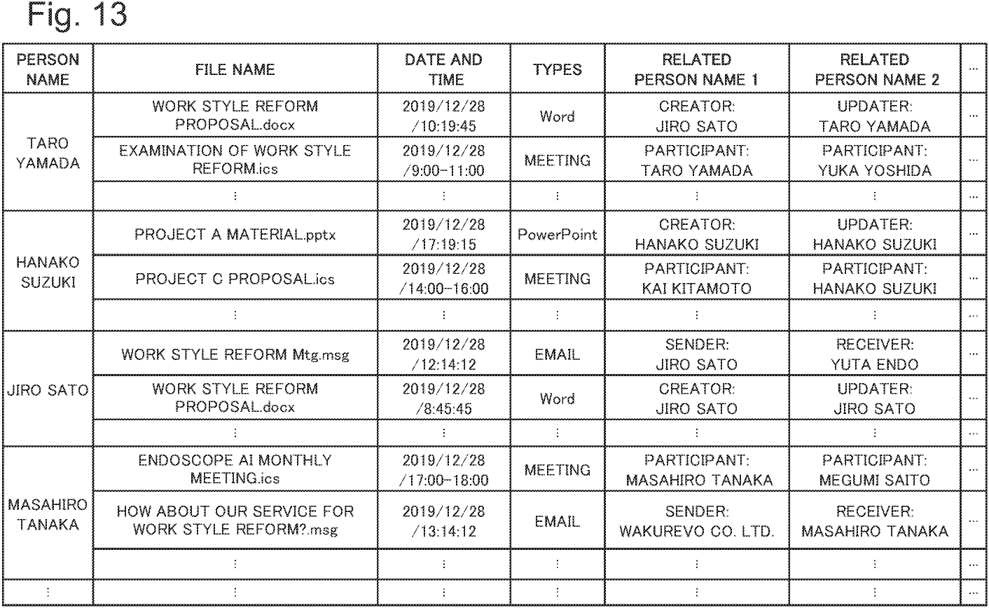

Hereinafter, each functional block constituting the person search system 3 will be described in detail with reference to FIG. 13 and subsequent drawings in addition to FIG. 12.

FIG. 13 is a diagram illustrating file information stored in the file information storage unit 37. As illustrated in FIG. 13, in the file information, for example, a person name is associated with a file name, a date and time, a type, and a related person name of a file used by the person.

The related person name is a person name included in the file. Specifically, in a case where the file type is “material”, for example, the related person name is the creator name and the updater name of the file. In a case where the file type is “meeting”, for example, the related person name is a participant name of the meeting. In a case where the file type is “email”, for example, the related person name is a sender name and a receiver name of the email. In addition, the related person name may be a person name described in the text of the file or a person name included in the metadata of the file.

The display control unit 34 controls the terminal device 100 to display the file information input from the file information acquisition unit 36.

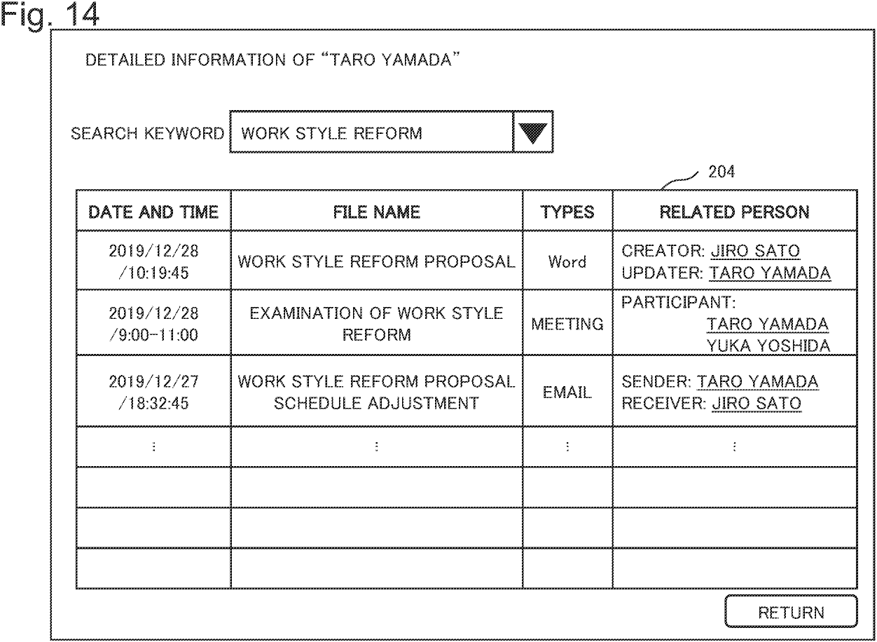

FIG. 14 is a diagram illustrating file information displayed on the terminal device 100 by the display control unit 34. As shown in FIG. 14, for example, the date and time, the file name, the type, and the related person of the file associated with “Taro YAMADA” received by the person selection reception unit 35 are displayed in the file information display area 204.

The person selection reception unit 35 receives selection of a person name to be an acquisition target of the file information from among related person names included in the file information displayed by the display control unit 34. The person selection reception unit 35 outputs the name of the person whose selection has been received to the file information acquisition unit 36.

For example, when the searcher selects the person name displayed in the file information display area 204 illustrated in FIG. 14 with a mouse or the like, the person selection reception unit 35 receives the selected person name.

The file information acquisition unit 36 acquires file information associated with the input person name based on the person name input from the person selection reception unit 35 and the file information stored in the file information storage unit 37. The file information acquisition unit 36 outputs the acquired file information to the display control unit 34.

The display control unit 34 controls the terminal device 100 to display the file information input from the file information acquisition unit 36.

For example, when the searcher selects “Jiro SATO” displayed in the file information display area 204 in FIG. 14, the detailed information of “Jiro SATO” is displayed by the same display method as that in FIG. 14.

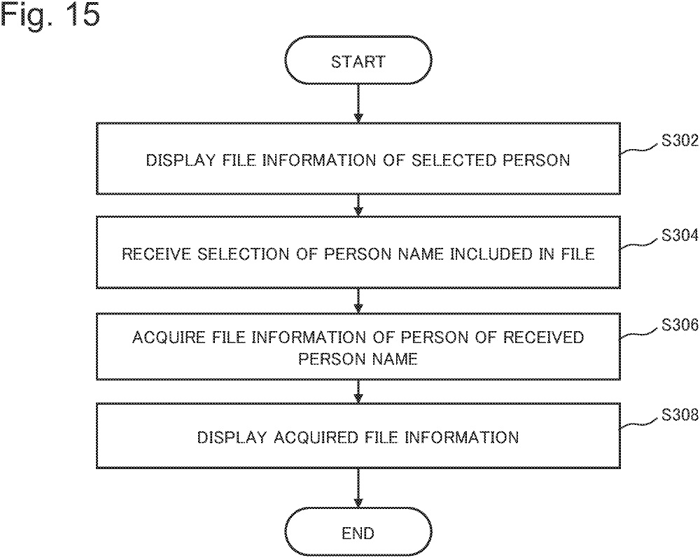

FIG. 15 is an example of a flowchart regarding transition to the detailed screen of the related person in the second example embodiment.

First, the display control unit 34 causes the terminal device 100 to display the file information of the person selected by the searcher and acquired by the file information acquisition unit 36. The file information acquired by the file information acquisition unit 36 includes related persons of the selected person (step S302).

Next, the person selection reception unit 35 receives the selection of the person name from the related person names displayed on the terminal device 100 (step S304).

Next, the file information acquisition unit 36 acquires the file information of the person having the person name received by the person selection reception unit 35 from the file information storage unit 37 (step S306).

Then, the display control unit 34 causes the terminal device 100 to display the file information acquired by the file information acquisition unit 36 (step S308).

As described above, according to the second example embodiment, the person search system 3 enables the searcher to know the related person of the person output as the search result. By displaying the related person, the person search system 3 enables the searcher to easily determine whether the related person of the searched person is a person he/she wants to contact.

For example, in the example of FIG. 14, the searcher is searching for a person who is familiar with the work style reform, and is able to know that Taro YAMADA updates the material of “Work style reform proposal” and is participating in a meeting of “Examination of work style reform”, and thus, it is possible to determine that there is a high possibility that Taro YAMADA is a person whom he/she wants to contact.

On the other hand, for example, from the file information of Masahiro TANAKA illustrated in FIG. 13, in a case where the detailed information of Masahiro TANAKA is displayed in the same manner as the screen illustrated in FIG. 14, the searcher can understand that Masahiro TANAKA has only received an email of “How about our service for work style reform?” from WAKUREVO CO. LTD. Therefore, the searcher can determine that the searcher should preferentially contact other people since he/she knows that Masahiro TANAKA has only received sales emails sent from companies to an unspecified number of people.

### Modification Example of Second Example Embodiment

In the second example embodiment, the case where the searcher selects a related person on the person search result screen (FIG. 14) to display detailed information on the selected person has been described as an example. As a modification example of the second example embodiment, a configuration in which the related person of all searched persons is displayed will be described.

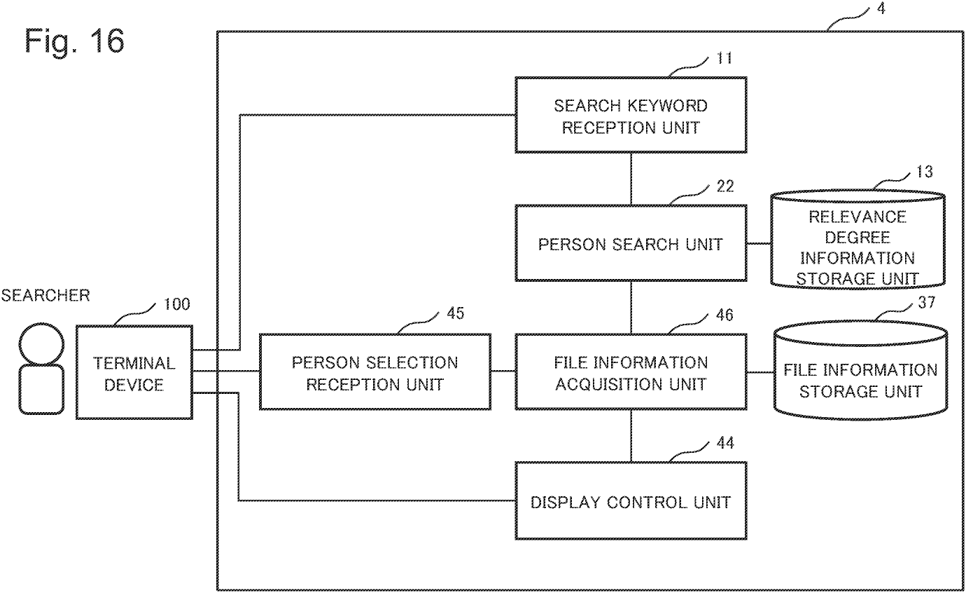

FIG. 16 is a diagram illustrating a configuration of a person search system 4 according to a modification example of the second example embodiment.

Among the configurations of the person search system 4, configurations that perform the same processing operations as those of the person search system 2 according to the modification example of the first example embodiment and the person search system 3 according to the second example embodiment are denoted by the same reference numerals as those in FIGS. 9 and 12, and a detailed description thereof will be omitted.

The person search system 4 illustrated in FIG. 16 includes the search keyword reception unit 11, the person search unit 22, the relevance degree information storage unit 13, a file information acquisition unit 46, the file information storage unit 37, a display control unit 44, and a person selection reception unit 45.

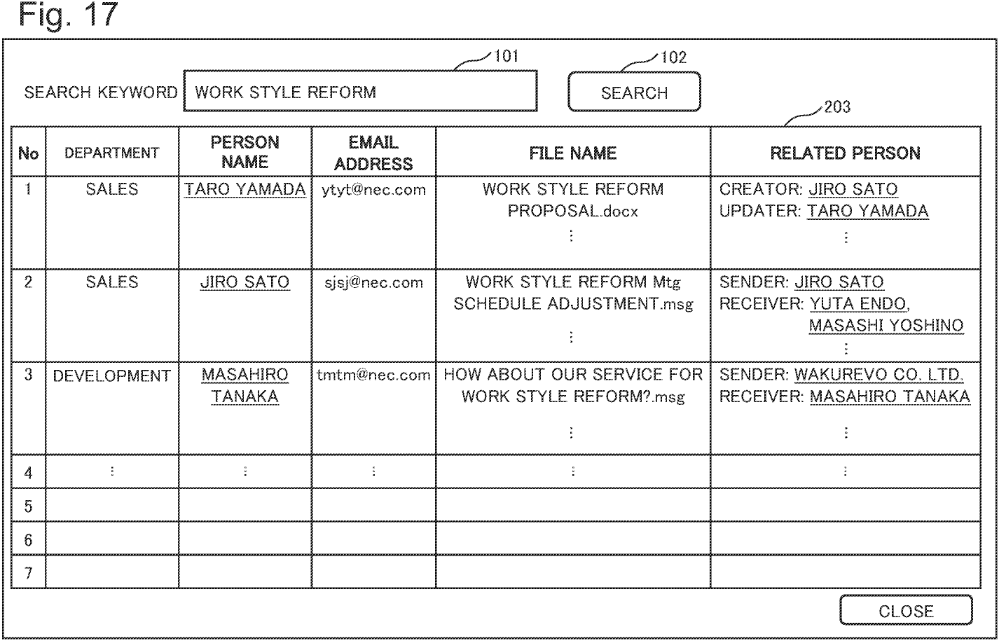

Hereinafter, each functional block constituting the person search system 4 will be described in detail with reference to FIG. 17 in addition to FIG. 16.

The search keyword reception unit 11, the relevance degree information storage unit 13, and the file information storage unit 37 are similar to those of the second example embodiment.

The person search unit 22 is similar to the modification example of the first example embodiment.

The file information acquisition unit 46 acquires file information associated with the person name of the searched person based on the person name of the person searched by the person search unit 22 and the file information stored in the file information storage unit 37. The file information acquisition unit 46 outputs the acquired file information to the display control unit 44.

The display control unit 44 controls the terminal device 100 to display the file information input from the file information acquisition unit 46.

FIG. 17 is an example of the search result screen and the file information displayed on the terminal device 100 by the display control unit 44. The search result display area 203 includes related persons associated with each person in addition to the searched person name, person attribute information, and file name. Therefore, the search result display area 203 can display the file information displayed in FIG. 14 in addition to the information of the search result screen displayed in FIG. 5. The file information displayed on the screen of FIG. 17 is not limited to the file name and the related person, and the date and time, the type, and the like may be displayed.

The person selection reception unit 45 receives the person name to be an acquisition target of the file information from among related person names included in the file information displayed by the display control unit 44. The person selection reception unit 45 outputs the received person name to the file information acquisition unit 46.

For example, when the searcher selects the person name displayed in the search result display area 203 illustrated in FIG. 17 with a mouse or the like, the person selection reception unit 45 receives the selected person name.

The file information acquisition unit 46 acquires file information associated with the input person name based on the person name input from the person selection reception unit 45 and the file information stored in the file information storage unit 37. The file information acquisition unit 46 outputs the acquired file information to the display control unit 44.

The display control unit 44 controls the terminal device 100 to display the file information input from the file information acquisition unit 46.

For example, when the searcher selects “Jiro SATO” displayed in the search result display area 203 in FIG. 17, the detailed information of “Jiro SATO” is displayed by the same display method as that in FIG. 14.

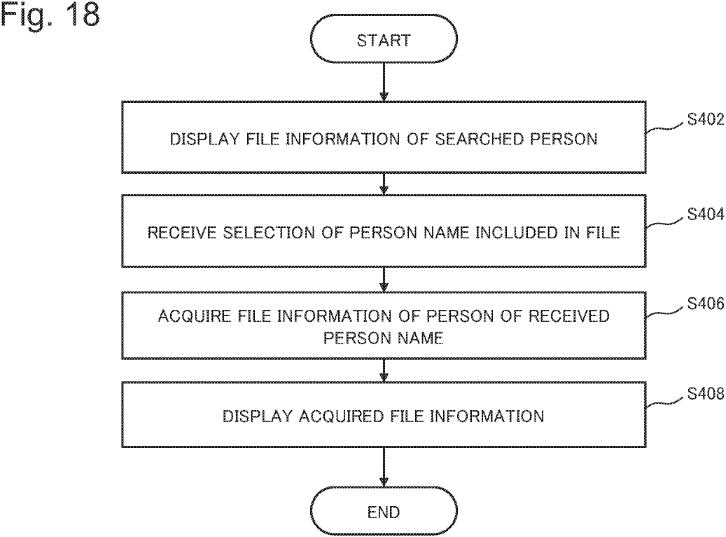

FIG. 18 is an example of a flowchart regarding transition to the detailed screen of the related person in the modification example of the second example embodiment.

First, the display control unit 44 causes the terminal device 100 to display the file information of the person searched by the searcher and acquired by the file information acquisition unit 46. The file information acquired by the file information acquisition unit 46 includes related persons of the searched person (step S402).

Next, the person selection reception unit 45 receives the selection of the person name from the person names that are included in the file and displayed on the terminal device 100 (step S404).

Next, the file information acquisition unit 46 acquires the file information of the person having the person name received by the person selection reception unit 45 from the file information storage unit 37 (step S406).

Then, the display control unit 44 causes the terminal device 100 to display the file information acquired by the file information acquisition unit 46 (step S408).

As described above, according to the modification example of the second example embodiment, the person search system 4 enables the searcher to know the related person of the person output as the search result. By displaying the related person, the person search system 4 enables the searcher to easily determine whether the related person of the searched person is a person he/she wants to contact.

### Third Example Embodiment

As a third example embodiment, a configuration related to a screen that can be displayed when a searcher logs in to a person search system will be described.

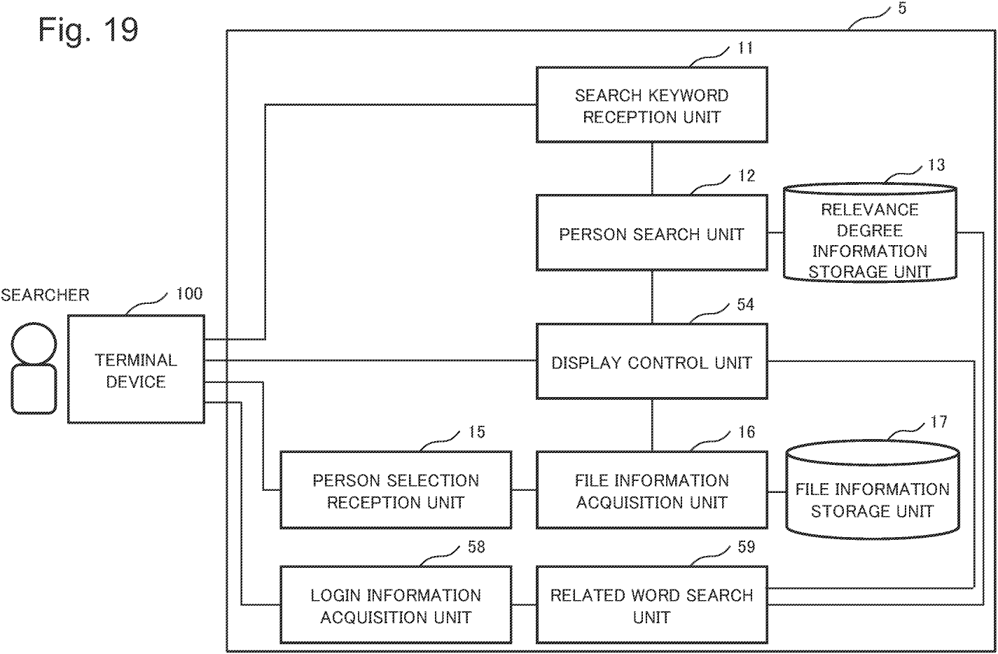

FIG. 19 is a diagram illustrating a configuration of a person search system 5 in the present example embodiment.

Among the components of the person search system 5, components that perform the same processing operations as those of the person search system 1 according to the first example embodiment are denoted by the same reference numerals as those in FIG. 1, and a detailed description thereof will be omitted.

The person search system 5 illustrated in FIG. 19 includes the search keyword reception unit 11, the person search unit 12, the relevance degree information storage unit 13, a display control unit 54, the person selection reception unit 15, the file information acquisition unit 16, the file information storage unit 17, a login information acquisition unit 58, and a related word search unit 59.

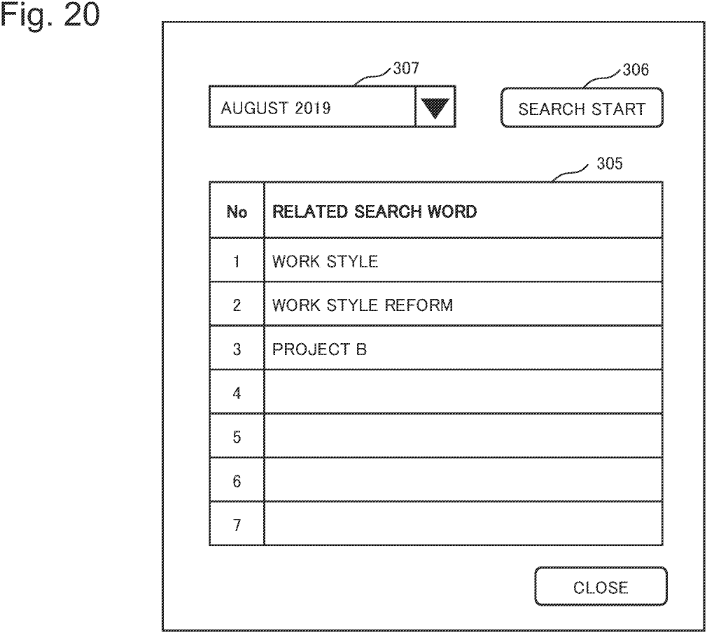

Hereinafter, each functional block constituting the person search system 5 will be described in detail with reference to FIG. 20 in addition to FIG. 19.

The search keyword reception unit 11, the person search unit 12, the relevance degree information storage unit 13, the person selection reception unit 15, the file information acquisition unit 16, and the file information storage unit 17 are similar to those of the first example embodiment.

FIG. 20 is an example of a top screen displayed when the searcher logs in to the person search system 5 for the purpose of person search. The top screen illustrated in FIG. 20 includes, for example, a related search keyword display area 305, a search start button 306 for starting a search, and a year/month selection tab 307.

The related search keyword display area 305 is an area in which search keywords having a high degree of relevance with the searcher name (hereinafter, “related search keyword” is also described) are displayed. The year/month selection tab 307 is a tab for selecting a designated year/month. When the searcher designates years or months from the year/month selection tab 307, the related search keywords of the searcher in the designated year/months are displayed in the related search keyword display area 305.

When the search start button 306 is pressed, for example, the display screen of FIG. 20 transitions to the display screen of FIG. 2.

The login information acquisition unit 58 acquires login information when the searcher logs in to the person search system 5. The login information is information including at least the searcher name. The login information acquisition unit 58 outputs the acquired login information to the related word search unit 59.

The related word search unit 59 searches, from the relevance degree information storage unit 13 for a search keyword having a high degree of relevance with the searcher name, that is, a related search keyword, based on the searcher name included in the login information acquired by the login information acquisition unit 58. The related word search unit 59 outputs the searched related search keyword to the display control unit 54.

The display control unit 54 controls the terminal device 100 to display the related search keyword input by the related word search unit 59.

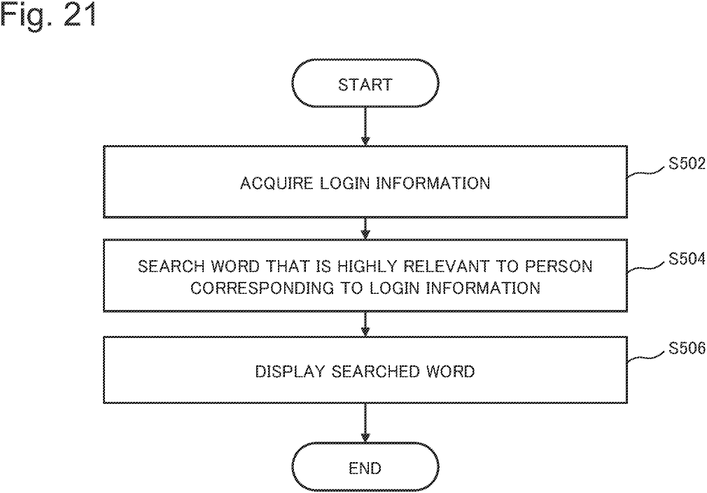

FIG. 21 is an example of a flowchart according to the third example embodiment.

First, the login information acquisition unit 58 acquires login information when the searcher logs in to the person search system 5 (step S502).

Next, the related word search unit 59 searches for the related search keyword corresponding to the searcher name included in the login information acquired by the login information acquisition unit 58 from the relevance degree information storage unit 13 (step S504).

Next, the display control unit 54 displays the related search keyword searched by the related word search unit 59 on the terminal device 100 (step S506).

As described above, according to the third example embodiment, the person search system 5 causes the searcher to easily determine a person to be contacted. By checking the search keyword associated with the searcher, the searcher can imagine the search keyword associated with the person whom the searcher desires to search, and can efficiently input the search keyword. Therefore, the searcher can efficiently search for a person that the searcher wants to contact from the persons output as the search results.

Although FIG. 20 illustrates the top screen at the time of login in the third example embodiment, FIG. 20 may display the top screen at any timing after the login information is acquired by the login information acquisition unit 58. For example, the display control unit 54 may display FIG. 20 when acquiring information indicating that the searcher desires to confirm the related word.

The person search system 5 according to the third example embodiment may receive processing of excluding a word that is not suitable as one’s specialty or a word that is not effective for person search in when the relevant search keyword is displayed to the searcher, in a case where the searcher itself determines that the word is included in the relevant search keyword.

The person search system 5 according to the third example embodiment may perform control such that person search cannot be performed according to authority information of the logged-in searcher. For example, in a case where a person who does not have the search authority logs in to the person search system 5, the search start button 306 in FIG. 20 may not be able to be pressed.

### Fourth Example Embodiment

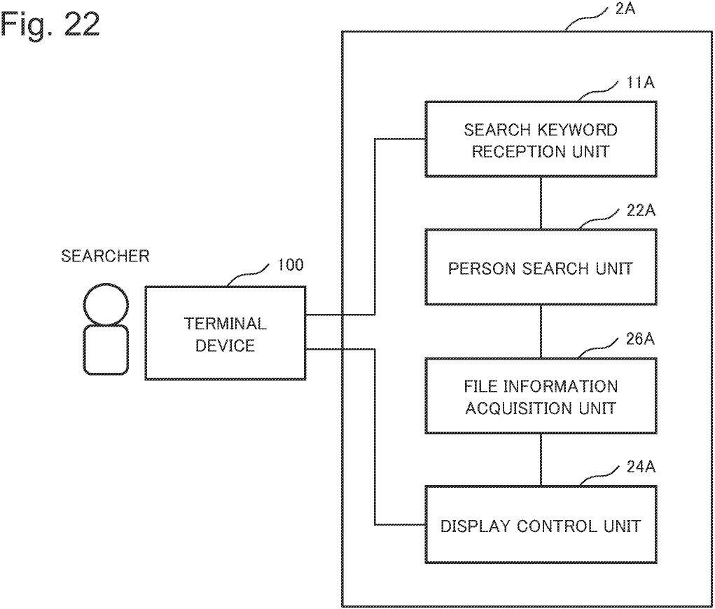

FIG. 22 is an example of functional blocks of a person search system 2A according to the present example embodiment.

The person search system 2A illustrated in FIG. 22 includes a search keyword reception unit 11A, a person search unit 22A, a file information acquisition unit 26A, and a display control unit 24A.

For example, the search keyword reception unit 11A, the person search unit 22A, the file information acquisition unit 26A, and the display control unit 24A can be configured similarly to the search keyword reception unit 11, the person search unit 22, the file information acquisition unit 26, and the display control unit 24, respectively, but are not limited thereto.

The search keyword reception unit 11A receives an input of a search keyword for searching for a person in the organization, and outputs the search keyword to the person search unit 22A. The person search unit 22A searches for a person related to the search keyword received by the search keyword reception unit 11A, and outputs the person to the file information acquisition unit 26A. The file information acquisition unit 26A acquires file information including at least a file name associated with the person searched by the person search unit 22A, and outputs the file information to the display control unit 24A. The display control unit 24A displays the file information acquired by the file information acquisition unit 26A.

Also according to the fourth example embodiment, the person search system 2A enables the searcher to easily determine whether the person is a person that the searcher wants to contact.

### Configuration Example of Hardware

A hardware configuration of the person search system according to each example embodiment of the present invention will be described below. Each functional configuration unit of the person search system in each example embodiment of the present invention may be implemented by hardware (for example, a hard-wired electronic circuit or the like) that implements each functional component, or may be implemented by a combination of hardware and software (for example, a combination of an electronic circuit and a program that controls the electronic circuit or the like). Hereinafter, a case where each functional configuration unit of the person search system according to each example embodiment of the present invention is implemented by a combination of hardware and software will be further described.

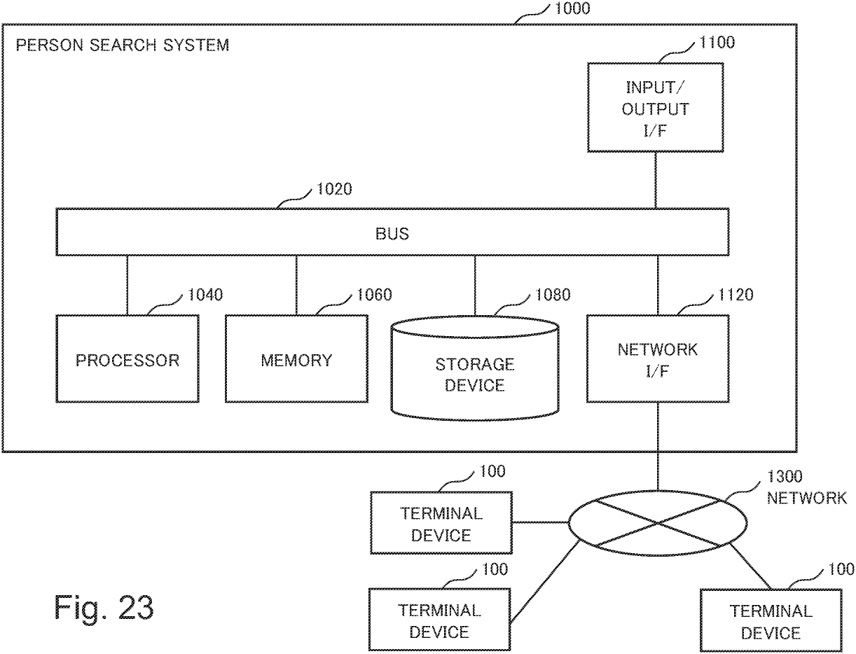

FIG. 23 is a diagram illustrating a calculator 1000, a network 1300, and a terminal device 100 for implementing the person search system according to each example embodiment of the present invention. The calculator 1000 is an arbitrary calculator. For example, the calculator 1000 is a personal computer (PC), a server machine, a tablet terminal, a smartphone, or the like. The calculator 1000 may be a dedicated computer designed to implement the person search system according to each example embodiment of the present invention, or may be a generalpurpose calculator.

The calculator 1000 includes a bus 1020, a processor 1040, a memory 1060, a storage device 1080, an input/output interface (I/F) 1100, and a network interface (I/F) 1120. The bus 1020 is a data transmission path for the processor 1040, the memory 1060, the storage device 1080, the input/output interface 1100, and the network interface 1120 to transmit and receive data to and from each other. However, the method for connecting the processor 1040 and the like to each other is not limited to the bus connection. The processor 1040 is various processors such as a central processing unit (CPU), a graphics processing unit (GPU), or a field-programmable gate array (FPGA). The memory 1060 is a main storage device implemented by using a random access memory (RAM) or the like. The storage device 1080 is an auxiliary storage device implemented by using a hard disk, a solid state drive (SSD), a memory card, a read only memory (ROM), or the like.

The input/output interface 1100 is an interface for connecting the calculator 1000 and an input/output device. For example, an input device such as a keyboard and an output device such as a display device are connected to the input/output interface 1100.

The network interface 1120 is an interface for connecting the calculator 1000 to the network 1300. The network is, for example, a local area network (LAN) or a wide area network (WAN). A method for connecting the network interface 1120 to the network may be a wireless connection or a wired connection.

Furthermore, each terminal device 100 is connected to the network 1300, and the calculator 1000 and each terminal device 100 can communicate data via the network 1300.

The storage device 1080 stores a program module that realizes each unit of the person search system in each example embodiment of the present invention. The processor 1040 reads and executes the program modules in the memory 1060, thereby implementing functions corresponding to the program modules.

Note that some functions of the person search system in each example embodiment of the present invention may be executed on each terminal device 100 side. That is, a processor, a storage device, and a memory may be stored inside each terminal device 100, and all or a part of the processing of each unit of the person search system in each example embodiment of the present invention may be executed using these components.

The terminal device 100 may include a touch panel display such as a smartphone. Furthermore, the terminal device 100 may be a personal computer (PC) and a display.

The present invention has been described above as an example applied to the example embodiments described above. However, the technical scope of the present invention is not limited to the scope described in each of the above-described example embodiments. It is obvious to those skilled in the art that various changes or improvements can be made to the example embodiments. In such a case, a new example embodiment to which such a change or improvement is added can also be included in the technical scope of the present invention. This is apparent from the matters described in the claims.

### INDUSTRIAL APPLICABILITY

Using the person search system of the present invention, the searcher can easily determine a person he/she wants to contact. Therefore, the searcher can easily find a person who is familiar with each field in an organization, particularly in a large-scale organization.

### Supplementary Notes

The configurations of the above-described example embodiments may be combined or some components may be replaced. The configuration of the present invention is not limited to the above-described example embodiments, and various modifications may be made without departing from the gist of the present invention.

Some of all of the above-described example embodiments may be described as in the following Supplementary Notes, but are not limited to the following.

### Supplementary Note 1

A person search system including:
receiving means configured to receive an input of search keywords for searching for a person in an organization;
search means configured to search for persons associated with the search keywords received by the receiving means;
acquisition means configured to acquire file information that includes at least a file name associated with persons searched for by the search means; and
display control means configured to display on a display device the file information acquired by the acquisition means.

### Supplementary Note 2

The person search system according to Supplementary Note 1, in which the file information further includes information indicating a file type of the file name.

### Supplementary Note 3

The person search system according to Supplementary Note 1 or 2, in which the display control means causes the display device to display the file information based on a degree of relevance between the file information and the search keyword.

### Supplementary Note 4

The person search system according to any one of Supplementary Notes 1 to 3, further including:
selection reception means configured to receive selection of an acquisition target person of the file information, in which
the acquisition means acquires file information including at least a file name associated with the person whose selection has been received by the selection reception means.

### Supplementary Note 5

The person search system according to Supplementary Note 4, in which the acquisition target person is a person searched for by the search means.

### Supplementary Note 6

The person search system according to Supplementary Note 4 or 5, in which the file information further includes a person name included in the file having the file name, and

the acquisition target person is a person with a person name included in the file.

### Supplementary Note 7

The person search system according to Supplementary Note 6, in which the person name included in the file is at least one of a creator name and an editor name of the file.

### Supplementary Note 8

The person search system according to Supplementary Note 6, in which the person name included in the file is a meeting participant name.

### Supplementary Note 9

The person search system according to Supplementary Note 6, in which the person name included in the file is at least one of a sender name and a receiver name of an email.

### Supplementary Note 10

The person search system according to any one of Supplementary Notes 1 to 9, further including:
login information acquisition means configured to acquire login information to the person search system; and
word search means configured to search for a word highly related to the person corresponding to the login information acquired by the login information acquisition means, in which
the display control means causes the display device to display the word searched by the word search means.

### Supplementary Note 11

A person search method including:
receiving an input of a search keyword for searching for a person in an organization;
searching for persons associated with the received search keyword;
acquiring file information including at least a file name associated with the searched person; and
causing a display device to display the acquired file information.

### Supplementary Note 12

The person search method according to Supplementary Note 11, in which the file information further includes information indicating a file type of the file name.

### Supplementary Note 13

The person search method according to Supplementary Note 11 or 12, in which the file information is displayed on the display device based on a degree of relevance between the file information and the search keyword.

### Supplementary Note 14

The person search method according to any one of Supplementary Notes 11 to 13, in which selection of an acquisition target person of the file information is received, and

file information including at least a file name associated with the acquisition target person is acquired.

### Supplementary Note 15

The person search method according to Supplementary Note 14, in which the acquisition target person is the searched person.

### Supplementary Note 16

The person search method according to Supplementary Note 14 or 15, in which the file information further includes a person name included in the file having the file name, and

the acquisition target person is a person with a person name included in the file.

### Supplementary Note 17

The person search method according to Supplementary Note 16, in which the person name included in the file is at least one of a creator name and an editor name of the file.

### Supplementary Note 18

The person search method according to Supplementary Note 16, in which the person name included in the file is at least one of a sender name and a receiver name of an email.

### Supplementary Note 19

The person search method according to any one of Supplementary Notes 11 to 18, in which login information of a person using the person search method is acquired,
a word highly related to the person corresponding to the login information is searched, and
the searched word is displayed on the display device.

### Supplementary Note 20

A storage medium storing a program for causing a computer to function as:
receiving means configured to receive an input of search keywords for searching for a person in an organization;
search means configured to search for persons associated with the search keywords received by the receiving means;
acquisition means configured to acquire file information that includes at least a file name associated with persons searched for by the search means; and
display control means configured to display on a display device the file information acquired by the acquisition means.

### REFERENCE SIGNS LIST

1, 2, 2A, 3, 4, 5 Person search system
11, 11A Search keyword reception unit
12, 22, 22A Person search unit
13 Relevance degree information storage unit
14, 24, 24A, 34, 44, 54 Display control unit
15, 35, 45 Person selection reception unit
16, 26, 26A, 36, 46 File information acquisition unit
17, 37 File information storage unit
58 Login information acquisition unit
59 Related word search unit
100 Terminal device
101 Input box
102 Search button
103, 103A, 203 Search result display area
104, 204 File information display area
305 Related search keyword display area
306 Search start button
307 Year/month selection tab
1000 Calculator
1020 Bus
1040 Processor
1060 Memory
1080 Storage device
1100 Input/output I/F
1120 Network I/F
1300 Network

What is claimed is:

1. A person search system comprising:
a memory storing instructions; and
one or more processors configured to execute the instructions to: receive an input of search keywords for searching for a person in an organization;
search for persons associated with the search keywords received;
acquire file information that includes at least a file name associated with persons searched for; and
display on a display device the file information acquired.

2. The person search system according to claim 1, wherein the file information further includes information indicating a file type of the file name.

3. The person search system according to claim 1, wherein the one or more processors are further configured to execute the instructions to:
cause the display device to display the file information based on a degree of relevance between the file information and the search keyword.

4. The person search system according to claim 1, wherein the one or more processors are further configured to execute the instructions to:
receive selection of an acquisition target person of the file information, and
acquire file information including at least a file name associated with the person whose selection has been received.

5.The person search system according to claim 4, wherein the acquisition target person is a person searched for.

6. The person search system according to claim 4, wherein the file information further includes a person name included in the file having the file name, and
the acquisition target person is a person with a person name included in the file.

7. The person search system according to claim 6, wherein the person name included in the file is at least one of a creator name and an editor name of the file.

8. The person search system according to claim 6, wherein the person name included in the file is a meeting participant name.

9. The person search system according to claim 6, wherein the person name included in the file is at least one of a sender name and a receiver name of an email.

10. The person search system according to claim 1, wherein the one or more processors are further configured to execute the instructions to:
acquire login information with respect to the person search system,
search for a word highly related to the person associated to the login information acquired, and
cause the display device to display the word searched.

11. A person search method comprising:
receiving an input of a search keyword for searching for a person in an organization;
searching for persons associated with the received search keyword;
acquiring file information including at least a file name associated with the searched person; and
causing a display device to display the acquired file information.

12. The person search method according to claim 11, wherein the file information further includes information indicating a file type of the file name.

13. The person search method according to claim 11, wherein the file information is displayed on the display device based on a degree of relevance between the file information and the search keyword.

14. The person search method according to claim 11, wherein selection of an acquisition target person of the file information is received, and
file information including at least a file name associated with the acquisition target person is acquired.

15. The person search method according to claim 14, wherein the acquisition target person is the searched person.

16. The person search method according to claim 14, wherein the file information further includes a person name included in the file having the file name, and
the acquisition target person is a person with a person name included in the file.

17. The person search method according to claim 16, wherein the person name included in the file is at least one of a creator name and an editor name of the file.

18. The person search method according to claim 16, wherein the person name included in the file is at least one of a sender name and a receiver name of an email.

19. The person search method according to claim 11, wherein login information of a person using the person search method is acquired,
a word highly related to the person associated to the login information is searched, and
the searched word is displayed on the display device.

20. A non-transitory computer-readable storage medium storing a program for causing a computer to function as:
receiving means configured to receive an input of search keywords for searching for a person in an organization;
search means configured to search for persons associated with the search keywords received by the receiving means;
acquisition means configured to acquire file information that includes at least a file name associated with persons searched for by the search means; and
display control means configured to display on a display device the file information acquired by the acquisition means.
